(19) United States
(12) Patent Application Publication
(10) Pub. No.: US 2014/0281019 A1
(43) Pub. Date: Sep. 18, 2014

(54) Network Transmission Adjustment Based On Application-Provided Transmission Metadata

(71) Applicant: MICROSOFT CORPORATION, Redmond, WA (US)

(72) Inventors: David A. Maltz, Bellevue, WA (US); David T. Harper, III, Seattle, WA (US); Douglas Christopher Burger, Bellevue, WA (US)

(73) Assignee: MICROSOFT CORPORATION, Redmond, WA (US)

(21) Appl. No.: 13/831,705

(22) Filed: Mar. 15, 2013

(51) Int. Cl. H04L 12/701

(52) U.S. Cl. CPC H04L 45/00
USPC 709/235

(57) ABSTRACT

Application-provided transmission metadata is utilized, in conjunction with current network information, to adjust network transmissions. An interface between applications seeking to transmit data and networking components enables the application to provide destination information, communication type information, information regarding the quantity of data to be transferred, timeliness information, data location information, cost information, and other like transmission metadata. Current network information can be obtained by the networking components themselves, or can be provided by, or enhanced by, a centralized controller. The networking components can then optimize both the routing and the protocol settings in the form of adjustments to error control settings, flow control settings, receiver control settings, segmentation settings, and other like protocol settings.

### BACKGROUND

Modern server computing devices are often physically configured in a manner to promote the installation and maintenance of multiple such server computing devices within a confined space, such as a rack. Multiple racks of server computing devices can then be housed in a dedicated facility, commonly referred to as a “datacenter”. Such datacenters offer efficiencies of scale and are often utilized to host the physical server computing devices that provide a myriad of services and functionality. For example, many services and functionalities accessible through the ubiquitous Internet and World Wide Web are supported by server computing devices in datacenters. Other services and functionalities, whose accessibility may be limited to corporate, university, or research intranets, are likewise supported by server computing devices in datacenters.

Often, to maintain reliability, redundant copies of data are maintained at multiple datacenters that are physically located separately and apart from one another. Such multiple datacenters can be spread throughout a single country, or around the world. In addition, other data sets can be sufficiently large that it is more economical, and more reliable, if portions of such data sets are maintained separately and apart from one another in multiple different datacenters, which, again, can be spread throughout a single country, or around the world.

Efficient data processing, however, typically requires that the data be stored on computer readable storage media that are physically proximate to the processing units of the server computing devices performing such data processing. Consequently, data processing can often entail the copying of large amounts of data from datacenters where such data is stored to datacenters where such processing may be performed. Alternatively, or in addition, data processing can often entail the copying of large amounts of data from the datacenter, where such data was processed, typically to generate new or modified data sets, to datacenters where such data is to be stored. The processing of such data can directly impact, or can even be triggered, by the provision of services to thousands, or even millions of users. Consequently, to enable such users to be more efficient, and to avoid user aggravation, it is typically desirable that the processing of such data be performed as quickly and efficiently as possible. However, the time required to copy data between datacenters, including the aggregation of data for processing, the subsequent disaggregation of data for storage, or other exchanges or transfers of data, are typically the limiting factors in how quickly and efficiently such processing can be performed.

### SUMMARY

In one embodiment, networking components can adjust protocol settings and routings to maximize the efficient transmission of data given known network conditions and given transmission metadata, from a sending application, which can describe how such data is to be transmitted.

In yet another embodiment, an interface can be defined between data transferring applications and networking components that can enable the data transferring applications to provide a myriad of transmission metadata to such networking components. The interface can enable the provision of transmission metadata, which can be in the form of: destination information, communication type information, information regarding the quantity of data to be transferred, timeliness information, data location information, cost information, and other like transmission metadata.

In a further embodiment, networking components can utilize transmission metadata to optimize protocol settings, which can be in the form of: adjustments to error control settings, flow control settings, receiver control settings, segmentation settings, and other like protocol settings. The optimization of such protocol settings can also take into account current network conditions.

In a still further embodiment, a centralized controller can provide information regarding current network conditions and network configurations to aid the networking components in optimizing the protocol settings and the routing for data to be transmitted.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary system for obtaining and utilizing transmission metadata to adjust network transmissions;

FIG. 2 is a block diagram of an exemplary architecture for obtaining and utilizing transmission metadata to adjust network transmissions;

FIG. 3 is a flow diagram of an exemplary utilization of transmission metadata to adjust network transmissions; and

FIG. 4 is a block diagram illustrating an exemplary general purpose computing device.

### DETAILED DESCRIPTION

The following description relates to the obtaining and utilizing of application-provided transmission metadata to adjust network transmissions. An interface can be defined between an application seeking to transmit data across a network and networking components to enable the application to provide transmission metadata to the networking components, which the networking components can then utilize, optionally in conjunction with current network condition information, to adjust routing and protocol settings applicable to the transmission of the data. Transmission metadata can include destination information, communication type information, information regarding the quantity of data to be transferred, timeliness information, data location information, cost information, and other like transmission metadata. With such transmission metadata, the networking components can optimize the protocol settings, in the form of adjustments to error control settings, flow control settings, receiver control settings, segmentation settings, and other like protocol settings. The networking components can also utilize current network condition information, such as a current network configuration and current network congestion information, in optimizing the protocol settings. Such current network information can be obtained by the networking components themselves, or can be provided by, or enhanced by, a centralized controller.

The techniques described herein make reference to specific types of networking environments and contexts. In particular, the descriptions below will be provided within the context of inter-datacenter communications between server computing devices. Such references, however, are strictly exemplary and are made for clarity of description and presentation and for ease of understanding. Indeed, the techniques described herein are equally applicable, without modification, to the optimization of any network transmissions, including, for example, transmissions by application programs executing on client computing devices, transmissions by dedicated network appliances, and transmissions by special purpose computing devices such as, for example, digital video recorders.

Although not required, aspects of the descriptions below will be provided in the general context of computer-executable instructions, such as program modules, being executed by a computing device. More specifically, aspects of the descriptions will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional server computing racks or conventional personal computers, and include other computing configurations, including hand-held devices, multi-processor systems, microprocessor based or programmable consumer electronics, network PCs, minicomputers, mainframe computers, and the like. Similarly, the computing devices need not be limited to a stand-alone computing device, as the mechanisms may also be practiced in distributed computing environments linked through a communications network. In a distributed computing environment, program modules may be located in both local and remote memory storage devices.

With reference to FIG. 1, an exemplary system 100 is illustrated, comprising multiple computing devices, such as the computing devices 111, 112 and 113, which can be physically located in one or more physically disparate datacenters, such as the datacenters 121, 122 and 123. The computing devices 111, 112 and 113, as well as other like computing devices at the datacenters 121, 122 and 123, can be networked together as part of the network 101, thereby enabling the transmission and sharing of computer-readable data among two or more computing devices. For purposes of the descriptions below, the datacenters 121, 122 and 123 can be networked together through a physical networking infrastructure having physical nodes 131, 132, 133 and 135 and segments 141, 142 and 143. As illustrated, the computing devices of the datacenter 121, such as the exemplary computing device 111, can be located proximally to the node 131 and the communications directed to the computing devices of the datacenter 121 can be routed to the datacenter 121 by the node 131, while other communications along the network 101 can be routed through the node 131, and on to other destinations, in such a manner that the computing devices of the datacenter 121 would be oblivious thereto. Similarly, the datacenter 122 can be located proximally to the node 132 and the datacenter 123 can be located proximally to the node 133.

Computer-executable instructions executing on one or more processing units of a computing device, such as the exemplary computing device 111, can seek to transmit data to other computing devices, including transmitting data across a network, such as the exemplary network 101. For example, the application 161, comprising computer-executable instructions executed in one or more of the processing units of the computing device 111, can seek to transmit data across the network 101. To do so, the application 161 can communicate with other computer-executable instructions executing on the computing device 111 that are dedicated to the transmission of data across a network and to the receipt of data received therefrom. Such computer-executable instructions are typically organized into one or more networking components, plug-ins, extensions, applications, and the like and are collectively referred to herein as a “network stack”. Thus, to transmit data across the network 101, the application 161, executing on the computing device 111, can communicate with the network stack 162, also executing on the computing device 111.

In one embodiment, an interface 163 can enable the application 161 to provide transmission metadata 164 to the network stack 162. Such transmission metadata 164 can then be utilized by the network stack 162 to adjust both the route, through the network 101, by which the network stack 162 sends the data being provided by the application 161, and the protocol settings utilized to communicate such data to one or more other computing devices. For example, the application 161 can seek to transmit the data 173 to the computing device 113 in the datacenter 123, and can also seek to transmit the data 172 to the computing device 112 in the datacenter 122. The network stack 162 can determine a routing 183 by which it will transmit the data 173, and can also determine the routing 182 by which it will transmit the data 172. Additionally, the network stack 162 can adjust the settings of the network transmission protocol 193 utilized to transmit the data 173, and can adjust the settings of the network transmission protocol 192 utilized to transmit the data 172. The determination of routings, such as the routings 182 and 183, and the adjustment of the settings of network transmission protocols, such as the protocol settings 192 and 193, can be informed by the transmission metadata 164 received by the network stack 162 from the application 161.

To provide further description of the interface 163, by which the application 161 can provide transmission metadata to the network stack 162, references are made to the system 200 of FIG. 2. Thus, turning to FIG. 2, the system 200 shown therein illustrates an exemplary association between the application 161 and the network stack 162, which can be executing on a computing device, such as the exemplary server computing device 111 that was shown in FIG. 1, as well as the association between the application 161 and the network stack 162 and hardware components of the computing device on which they are executing, namely the memory 210 in the hardware network interface 220. As illustrated by the system 200 of FIG. 2, the transmission metadata interface 163, between the application 161 and the network stack 162, can enable the provision, by the application 161, of multiple different types of information associated with, and describing, the network transmissions that the application 161 seeks to undertake.

One type of transmission metadata 164 that the application 161 can provide, via the interface 163, can be quantity of data information 233. As will be recognized by those skilled in the art, typically, application programs transmit data by simply providing, to networking components, one or more pointers to such data, typically as such data either becomes available to the application or is generated by the application. Consequently, networking components are typically unaware and, indeed, typically agnostic to, the total quantity of data that is to be transmitted. However, in one embodiment, the transmission metadata 164 can include information regarding the quantity of data that the application 161 seeks to transmit so as to enable the network stack 162 to perform various optimizations and adjustments in the manner in which such data is transmitted. As an initial matter, the network stack 162 can compare the quantity of data information 233 to one or more thresholds to determine whether it is optimal for the network stack 162 to even invest the time and processing resources to optimize the transmission of the data. For example, if the quantity of data being transmitted is small, such that the efficiencies gained by any optimizations performed by the network stack 162 would be more than negatively offset by the time and resources taken to identify and perform such optimizations in the first place, then overall efficiency can be increased if the network stack 162 simply performs no optimizations on such transmissions of small quantities of data.

The transmission metadata interface 163 can also provide for the provision of communication type information 232. For example, the transmission metadata 164 can include an indication that the data currently sought to be transmitted by the application 161 is part of communications that comprise periodic transmissions of data of a delineated size. Alternatively, the application 161 can specify, via the communication type information 232, that the data it seeks to transmit is a single message, or is part of a single request/response exchange. In yet another alternative, the communication type information 232 can specify that the data sought to be transmitted is part of a stream of data, which can be indicated as an unbounded stream, a request/response stream, or other like specificity can be provided. In one embodiment, the communication type information 232 can be utilized with the quantitative data information 233 to enable the network stack 162 to determine whether to invest the time and resources to optimize the transmission of data. For example, the network stack 162 can determine that it should seek to optimize the transmission of data, even if the data currently sought to be transmitted by the application 161, as indicated by the quantity of data information 233, is smaller than a threshold quantity of data, if the communication type information 232 indicates that the data currently being transmitted is one of periodic transmissions of data. In such an instance, the one-time investment of time and resources to perform such an optimization, while it may not be recouped with the transmission of the data currently sought to be transmitted, can, ultimately, be recouped by the more efficient transmission of subsequent data of the same type, due to the periodic nature indicated by the communication type information 232.

The communication type information 232 and quantity of data information 233 can also be utilized by the network stack 162 to optimize the settings of the communication protocol with which such data is transmitted. As indicated by the interface 240 between the network stack 162 and the network hardware interface 220, the network stack 162 can, among other options and settings, adjust the error control 241, the flow control 242, the receiver control 243 and the segmentation 244 that are applied to the transmission of the data sought to be transmitted by the application 161. Thus, for example, if the quantity of data information 233 indicated that the data, which the application sought to transmit, was small, and the communication type information 232 indicated that the data was part of a periodic transfer of data over the fixed size, then the network stack 162 could adjust the protocol settings for the transfer of such data to be suitable for the sending of short messages. As one example, the error control 241 and flow control 242 could specify a congestion provider tailored to the sending of short messages, together with a short minimum retransmission timeout and a small quantity of packets that need to be received before an acknowledgment is sent.

Other of the information that can be provided via the transmission metadata interface 163 can be information that can aid the network stack 162, in optimizing, not just the protocol by which the data, described by the transmission metadata, is sent, but also the route, through the network, along which such data would be transmitted. For example, the destination information 231 can comprise information regarding the destination of the data that the application 161 seeks to transmit, including, for example, the network address of the destination computing device and, optionally, the targeted application on such a destination computing device to which such data would be directed. Similarly, the timeliness information 234, together with the cost information 236, can enable the network stack 162 to identify optimized routing for the data to be transferred. For example, and as will be recognized by those skilled in the art, the utilization of network bandwidth to transmit data is not costless and, consequently, a concept of cost, or how much an application is willing to “pay” to transmit data, can be utilized to assign and dole out limited network resources, such as bandwidth. Consequently, if the application 161 specifies aggressive timeliness information 234, such that the data it seeks to transmit becomes worthless, and should just be discarded, if not received by the destination within a certain period of time, the network stack 162 can identify routings that can satisfy the timeliness information 234, but such routings may incur a cost that is greater than the amount that the application 161 is willing to incur, which can be specified by the cost information 236. In such an instance, the network stack 162 can simply not transmit the data in the first place, since it can be aware that the limitation specified by the timeliness information 234 cannot be met with the acceptable cost specified by the cost information 236. Conversely, if the timeliness information 234 specifies a relaxed deadline, but the cost information 236 specifies a minimal cost, the network stack 162 can identify routings that may have greater latency than other routings, but such identified routings can satisfy the cost information 236.

To aid the network stack 162 in the optimized transmission of data across the network, the application 161 can also specify location of data information 235 as part of the transmission metadata interface 163. Such information can, in one embodiment, be utilized to conserve time and resources by avoiding unnecessary copies of the data to be transmitted. For example, and as will be understood by those skilled in the art, typically the transmission of data across a network can involve generating multiple copies of such data within the sending computing device before the data is even sent. For example, the application 161 can maintain the data to be transmitted in a portion of the memory 210 that is assigned to the application 161. Subsequently, upon attempting to transmit such data, the network stack 162 can copy such data from the portion of the memory 210 in which the application 161 has stored such data, to a different portion of the memory 210. A still further copy of the data in the memory 210 may be made by the network hardware interface 220. Thus, in one embodiment, to optimize transmission of data across the network, such multiple copies of data, especially within the memory 210, can be avoided. More specifically, the network stack 162 can utilize the location of data information 235, provided by the application 161, to access the one, same copy of the data in the same portion of the memory 210 as the application 161, thereby avoiding further copying of the data within the memory 210 prior to transmission.

As indicated previously, the transmission metadata provided by the application 161, via the transmission metadata interface 163, can comprise information that can enable the network stack 162 to optimize the routing of such data across a network. In performing such routing, the network stack 162 can reference, not only information received via the transmission metadata interface 163, but can also reference information about the network, such as a current configuration of the network, and a current congestion of the network. Turning back to the system 100 of FIG. 1, the exemplary network 101 shown therein can comprise a configuration whereby, to transmit the data 172 to the computing device 112, the network stack 162, executing on the computing device 111 and seeking to transmit data therefrom, can route the data along the segment 141 and then the segment 142. Thus, when routing the data 172, the network stack 162 can utilize a routing 182 that can route the data 172 along the segments 141 and 142.

Depending on the factors of a routing, such as the routing 182, the network stack 162 can adjust the protocol settings 192 utilized to transmit the data 172 along the determined routing 182. For example, if the network stack 162 received information that the segment 142 of the network 101 was currently congested, it could adjust the protocol settings 192 to, for example, incorporate a long minimum retransmission timeout, to avoid retransmitting due to a timeout that is not actually the result of a failure of a communication to reach its destination, but rather is simply due to the known delay introduced by the congestion along the segment 142 of which the network stack 162 was informed. As another example, the network stack 162 can adjust the protocol settings 192 to incorporate an extended period of time delay before an acknowledgment is sent, and can, thereby, by increasing the possibility that the delayed acknowledgment can be a cumulative acknowledgment of multiple packets, reduce the overall quantity of acknowledgments that are sent and, thereby, also reduce the volume of network traffic along an already congested segment. As yet another example, network stack 162 can determine, based on the configuration of the network 101, that a routing 183, directing the data 173 along the segments 141 and 143, can be utilized to transmit the data 173 from the computing device 111 to the computing device 113. Additionally, network stack 162 can learn that neither the segments 141 or 143 are currently experiencing any congestion. Consequently, as an example, network stack 162 can adjust protocol settings 193 to provide for a congestion provider that could ignore at least some packet loss and avoid throttling down the speed with which the data 173 is transmitted, since, as will be known by those skilled in the art, traditional congestion providers assume packet loss is due to congestion and typically respond by reducing the rate at which data is transmitted. The setting of the routing, such as the routing 182 and 183, in the adjustment of the protocol settings, such as the protocol settings 192 and 193, by the network stack 162, in response to the transmission metadata 164 and network configuration and, optionally, network status, is graphically illustrated in the system 100 of FIG. 1 by the arrows 168 and 169, respectively.

In one embodiment, the network stack 162 can obtain routing and, especially, congestion information, in a reactive manner. For example, upon receiving data to be transmitted, which the network stack 162 can determine would benefit from optimization, such as the optimizations described in detail above, the network stack 162 can transmit explorer packets to nearby (in a network sense) computing devices to learn of the network configuration and conditions between the computing device 111 on which the network stack 162 is executing and those nearby computing devices. Upon receiving responses to such explorer packets, the network stack 162 can derive information regarding the network configuration and conditions and can, optionally, request at least some of those nearby computing devices to transmit further explore packets to their nearby computing devices. In such a manner a reactive exploration of the network 101 can be undertaken by the network stack 162.

In another embodiment, the network stack 162 can utilize a gossip protocol to proactively maintain information regarding the configuration and conditions of the network 101. For example, the computing device 111 can have had multiple previous communicational exchanges with other computing devices throughout the network 101 including, for example, the computing devices 112 and 113. From such communicational exchanges, the network stack 162 can obtain not only the data that was destined for the computing device 111, but can also identify aspects of the status of the network 101. For example, if prior communications between the computing device 111, on which the network stack 162 is executing, and the computing device 112 required repeated retransmissions due to packets that were received after they were expected, the network stack 162 can determine that at least one of the segments 141 and 142, through which such communications were routed, is congested. Continuing such an example, if prior communications between the computing device 111 and the computing device 113 did not require such repeated retransmissions, the network stack 162 can further determine that the segments 141 and 143, through which such communications were routed, are not congested. From such information, the network stack 162 can further determine that since congestion existed in at least one of segments 141 and 142, but not in segment 141 and 143, then segment 142 must be experiencing congestion.

In yet another embodiment, the network stack 162 can receive network information, such as network configuration information 155 and network congestion information 156, from a centralized controller 150 that can be part of the network 101 and can monitor aspects of the network 101, and receive information therefrom, such as, for example, the congestion information 151. The centralized controller 150, and associated information, is illustrated in FIG. 1 with dashed lines to indicate that it is an optional component.

Turning to FIG. 3, the flow diagram 300 shown therein illustrates an exemplary series of steps by which transmission metadata can be utilized to optimize the transmission of data across a network. Initially, at step 310, an indication can be received, such as from an application, that such an application desires to transmit data over the network to another computing device. Subsequently, at step 320, transmission metadata can be received, such as via a transmission metadata interface. The transmission metadata can include, for example, information describing the destination of such data, information specifying a minimum latency, expiration date, or other like timeliness information, information specifying a type of communication, such as whether the data that the application seeks to transmit is a single block of data or part of a stream, or whether it is a single event or part of a periodic exchange, the quantity of the data that the application seeks to transmit, the location of the data, such as in memory, that the application seeks to transmit, and information specifying a priority of the data, such as the costs that the application is willing to incur in transmitting such data in a manner that will satisfy the other requirements that can have been specified via the transmission metadata interface.

At step 330, in one embodiment, as a threshold, a determination can be made whether, based upon the transmission metadata received at step 320, the costs incurred in attempting to optimize the transmission of such data will be recouped in the form of greater data transfer efficiency. For example, and as indicated previously, for small quantities of data, the costs incurred in determining optimized routings and optimized protocol settings can be greater than the resulting efficiency realized in such an optimized network transmission. Consequently, in such an example, the determination, at step 330, could determine that it is inappropriate to attempt an optimization. In such an instance, processing can proceed to transmit the data, as indicated by step 370. The relevant processing can then end at step 380.

Conversely, if, at step 330, it is determined, based upon the transmission metadata received at step 320, that an optimization should be undertaken, then processing can proceed to step 340 where, optionally, in one embodiment, network congestion information, or other like network status information, can be obtained. As indicated previously, such congestion information can be obtained proactively, such as through a gossip protocol, or other gleaning of information from preceding communications, reactively, such as by transmitting explorer packets to other computing devices, externally, such as from a centralized source, and the like. As before, dashed lines are utilized in FIG. 3 to illustrate that step 340 is optional.

At step 350 a routing can be generated, either to an intermediate destination, such as if a store-and-forward mechanism of data transmission was utilized, or to the final destination to which the application sought to transmit the data. The routing determined at step 350 can be informed by the configuration of the network, as well as the transmission metadata received at step 320. For example, if the transmission metadata 320 comprised timeliness information that indicated a relaxed time constraint, the network configuration could provide for multiple routes, including circuitous routes that may result in greater latency. However, if the transmission metadata 320 also comprised priority information that indicated that the application sought to minimize the costs of the transmission of such data, or that the application was not willing to incur anything but a low cost to transmit such data, then, at step 350, not only can the multiple routes be identified, but they can be filtered so as to select a least costly route as the routing to be applied to the transmission of the data. Additionally, if available, network congestion information, or other like network status information can be utilized to generate or inform the routing at step 350. For example, congestion information may reveal that only a specific, least congested, route can reliably deliver the data to the destination and satisfy the timeliness requirements provided by the transmission metadata 320.

In one embodiment, it is possible that, at step 350, a determination is made that there does not exist a routing which can satisfy the requirements provided by the transmission metadata at step 320. In such an instance, at step 350, a determination can be made to not transmit any of the data, thereby achieving efficiencies by avoiding transmission of data that would not satisfy applications requirements anyway. In a further embodiment, in such an instance, an additional component of step 350 can be a notification, to the application providing the transmission metadata, that the transmission metadata, which was provided at step 320, is in conflict with the current capabilities of the network and that the application can either change some or all of the transmission metadata, or can attempt to transmit the data at a subsequent time.

At step 360, the protocol settings to be utilized to transmit the data can be adjusted to optimize the transmission of the data. Such protocol settings can seek to optimize the transmission based upon the transmission metadata received at step 320 and, optionally, if available, based upon congestion information obtained at step 340. As indicated previously, such protocol settings can include, but are not limited to, error control, flow control, receiver control and segmentation. For example, if, based upon the routing determined at step 350, and the congestion information obtained at step 340, it is determined that the selected routing is not experiencing any congestion upon it, then the error control protocol settings can be adjusted to select a congestion provider that can ignore at least some packet loss and continue to transmit data at a higher rate. As another example, if, based upon the transmission metadata received at step 320, it is determined that the data to be transmitted is of a small quantity, than the protocol settings can be adjusted to, for example, specify a short minimum retransmission timeout and a small quantity of packets that need to be received before an acknowledgment is sent, thereby optimizing the transmission for small quantities of data. Once the protocol settings are optimized at step 360, the data can be transmitted at step 370. The relevant processing can then end at step 380.

Turning to FIG. 4, an exemplary computing device, representative of those whose operations were described in detail above, is illustrated. The exemplary computing device 400 can include, but is not limited to, one or more central processing units (CPUs) 420, a system memory 430 and a system bus 421 that couples various system components including the system memory to the processing unit 420. The system bus 421 may be any of several types of bus structures including a memory bus or memory controller, a peripheral bus, and a local bus using any of a variety of bus architectures. Depending on the specific physical implementation, one or more of the CPUs 420, the system memory 430 and other components of the computing device 400 can be physically co-located, such as on a single chip. In such a case, some or all of the system bus 421 can be nothing more than communicational pathways within a single chip structure and its illustration in FIG. 4 can be nothing more than notational convenience for the purpose of illustration.

The computing device 400 also typically includes computer readable media, which can include any available media that can be accessed by computing device 400. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. Computer storage media, however, does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computing device 400, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, other program modules 445, and program data 436.

When using communication media, the computing device 400 may operate in a networked environment via logical connections to one or more remote computers. The logical connection depicted in FIG. 4 is a general network connection 471 to a network 490, which can be a local area network (LAN), a wide area network (WAN) such as the Internet, or other networks. The computing device 400 is connected to the general network connection 471 through a network interface or adapter 470 that is, in turn, connected to the system bus 421. In a networked environment, program modules depicted relative to the computing device 400, or portions or peripherals thereof, may be stored in the memory of one or more other computing devices that are communicatively coupled to the computing device 400 through the general network connection 471. It will be appreciated that the network connections shown are exemplary and other means of establishing a communications link between computing devices may be used.

The computing device 400 may also include other removable/non-removable, volatile/nonvolatile computer storage media. By way of example only, FIG. 4 illustrates a hard disk drive 441 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440.

The drives and their associated computer storage media discussed above and illustrated in FIG. 4, provide storage of computer readable instructions, data structures, program modules and other data for the computing device 400. In FIG. 4, for example, hard disk drive 441 is illustrated as storing operating system 444, other program modules 445, and program data 446. Note that these components can either be the same as or different from operating system 434, other program modules 435 and program data 436. Operating system 444, other program modules 445 and program data 446 are given different numbers here to illustrate that, at a minimum, they are different copies.

As can be seen from the above descriptions, mechanisms for obtaining and utilizing transmission metadata for optimizing network transmissions have been presented. Which, in view of the many possible variations of the subject matter described herein, we claim as our invention all such embodiments as may come within the scope of the following claims and equivalents thereto.

We claim:

1. A method of generating routing and protocol settings for a transmission of data over a portion of a network, the method comprising the steps of:
receiving, from an application seeking to transmit the data over the portion of the network, transmission metadata associated with the data, the transmission metadata comprising at least two of: a destination information, a timeliness information, a communication type information, a quantity of data information, a location of data information, and a cost information;
generating the routing based on at least some of the transmission metadata; and
generating the protocol settings by specifying at least one of: error control, flow control, receiver control and segmentation based on at least some of the transmission metadata.

2. The method of claim 1, further comprising the steps of obtaining network congestion information specifying congestion in the network.

3. The method of claim 2, wherein the obtaining the network congestion information comprises transmitting explorer packets to a least some nearby computing devices.

4. The method of claim 2, wherein the obtaining the network congestion information comprises deriving the network congestion information from transmission information associated with data previously received, which was transmitted over the portion of the network.

5. The method of claim 2, wherein the obtaining the network congestion information comprises requesting the network congestion information from a centralized controller configured to monitor the congestion in the network.

6. The method of claim 1, wherein the generating the protocol settings comprises generating the protocol settings with a short minimum retransmission timeout and a small quantity of packets that need to be received before an acknowledgment is sent if the transmission metadata indicates that the data being transmitted is of a small quantity.

7. The method of claim 1, wherein the generating the protocol settings comprises generating the protocol settings with a congestion provider that will ignore at least some packet loss and continue to transmit data at a higher rate if network congestion information indicates a lack of congestion on the portion of the network.

8. The method of claim 1, wherein the generating the protocol settings comprises generating the protocol settings with either: an extended period of time delay before an acknowledgment is sent, or a long minimum retransmission timeout, if network congestion information indicates congestion on the portion of the network.

9. A computing device comprising:
a network hardware interface communicationally coupling the computing device to a network;
an application program comprising data to be transmitted over a portion of the network and computer-executable instructions which, when executed by the computing device, cause the application to provide transmission metadata via a transmission metadata interface, the transmission metadata describing the data to be transmitted; and
a network stack comprising computer-executable instructions which, when executed by the computing device, cause the network stack to perform steps comprising: receiving the transmission metadata, generating a routing of the data across the portion of the network based on at least some of the transmission metadata; and generating protocol settings, based on at least some of the transmission metadata, by which the data will be transmitted over the portion of the network.

10. The computing device of claim 9, further comprising a memory accessible by the application program and the network stack, the memory comprising the data as stored by the application program in the memory; wherein the transmission metadata comprises a pointer to a location in the memory at which the data is stored by the application program; and wherein further the network stack comprises further computer-executable instructions for transmitting the data directly from the location in the memory.

11. The computing device of claim 9, wherein the transmission metadata comprising at least two of: a destination information, a timeliness information, a communication type information, a quantity of data information, a location of data information, and a cost information.

12. The computing device of claim 9, wherein the generated protocol settings specify at least one of: error control, flow control, receiver control and segmentation based on at least some of the transmission metadata.

13. The computing device of claim 9, wherein the network stack comprises further computer-executable instructions for obtaining network congestion information specifying congestion in the network.

14. The computing device of claim 13, wherein the computer-executable instructions for obtaining the network congestion information comprise computer-executable instructions for transmitting explorer packets to a least some nearby computing devices.

15. The computing device of claim 13, wherein the computer-executable instructions for obtaining the network congestion information comprise computer-executable instructions for deriving the network congestion information from transmission information associated with data previously received by the computing device, which was transmitted over the portion of the network.

16. The computing device of claim 9, wherein the computer-executable instructions for generating the protocol settings comprise computer-executable instructions for generating the protocol settings with a short minimum retransmission timeout and a small quantity of packets that need to be received before an acknowledgment is sent if the transmission metadata indicates that the data being transmitted is of a small quantity.

17. The computing device of claim 9, wherein the computer-executable instructions for generating the protocol settings comprise computer-executable instructions for generating the protocol settings with a congestion provider that will ignore at least some packet loss and continue to transmit data at a higher rate if network congestion information indicates a lack of congestion on the portion of the network.

18. The computing device of claim 9, wherein the computer-executable instructions for generating the protocol settings comprise computer-executable instructions for generating the protocol settings with either: an extended period of time delay before an acknowledgment is sent, or a long minimum retransmission timeout, if network congestion information indicates congestion on the portion of the network.

19. One or more computer-readable media comprising computer-executable instructions for transmitting data over a portion of a network, the computer-executable instructions directed to steps comprising:
receiving, from an application seeking to transmit the data over the portion of the network, transmission metadata associated with the data, the transmission metadata comprising at least two of: a destination information, a timeliness information, a communication type information, a quantity of data information, a location of data information, and a cost information;
generating the routing based on at least some of the transmission metadata; and
generating the protocol settings by specifying at least one of: error control, flow control, receiver control and segmentation based on at least some of the transmission metadata.

20. The computer-readable media of claim 19, wherein the computer-executable instructions for generating the protocol settings comprise computer-executable instructions for generating the protocol settings with a congestion provider that will ignore at least some packet loss and continue to transmit data at a higher rate if network congestion information indicates a lack of congestion on the portion of the network.
